(19) United States
(12) Patent Application Publication
(10) Pub. No.: US 2026/0246327 A1
(43) Pub. Date: Aug. 20, 2026

(54) HAIRPIN WINDING WITH MODIFIED RETURN REGION

(71) Applicant: ZF FRIEDRICHSHAFEN AG, Friedrichshafen (DE)

(72) Inventor: Julian WINKLER, Elfershausen (DE)

(21) Appl. No.: 19/471,449

(22) PCT Filed: Mar. 27, 2024
(86) PCT No.: PCT/EP2024/058348

§ 371 Date: Oct. 1, 2025

(30) Foreign Application Priority Data
Apr. 4, 2023 (DE) 10 2023 203 093.4

(51) Int. Cl. H02K 3/28

(52) U.S. Cl. CPC H02K 3/28

(57) ABSTRACT

A winding with hairpins for an electric component of an electric machine with at least one phase, a hole count of at least three, and two or three parallel-connected coil strands per coil and phase. The winding extends over a first outer layer, a plurality of middle layers and a second outer layer with a changing winding direction. The change in the winding direction takes place in a return region via, in each instance, one hairpin, referred to as return hairpin, per coil strand in one of the outer layers on a head side of the winding. At least two of the return hairpins have a winding pitch that deviates from a standard winding pitch sWS.

The invention is directed to a winding with hairpins for an electric component of an electric machine, such as a stator or a rotor, an electric axle drive and a motor vehicle.

A winding with hairpins, or hairpin winding, is a winding comprising coils which are formed in each instance by at least one coil strand which in turn comprises a plurality of hairpins which are electrically connected to one another. A hairpin is a shaped bar, generally with a rectangular cross section, which has a U-shape with two parallel conductor members which are monolithically connected to one another along a turn region, also known as a winding head, and accordingly have two ends on a same side. The ends of the hairpins are electrically conductively connected to one another so that the hairpins are connected in series to form a coil strand. One or more parallel-connected coil strands forms a coil. The ends of the coil strands which are formed in each instance by a free end of a hairpin or I-pin terminating the respective coil strand are referred to as connection pins. In the case of coil strands in a lamination stack of a toroidal stator, the hairpins lie in parallel, axially extending slots in a plurality of winding layers. The winding layers comprise at least one radially outer layer, one radially inner layer and a plurality of middle layers.

The interconnection of the hairpins with one another and with the individual phases and their arrangement in determined slots and determined layers characterize the winding pattern of the winding and, hence, the winding. The winding should be configured in such a way that an electric machine in which the winding is applied has a smooth operation and only produces little operating noise. The occurrence of circulating currents and harmonics should be prevented, and the most uniform possible mutual induction of parallel coil strands should be achieved, which leads to the most homogeneous possible rotating, superimposed magnetic field.

For the description of a winding or winding pattern, the side on which the hairpins are interconnected with one another is referred to as the twist side. The opposite side, on which the winding heads are located, will be referred to as the head side. The spacing of the two parallel conductor members of a hairpin is determined by the spacing of the two slots in which the two conductor members of the hairpin are located and is given by the quantity of spanned slots plus one and referred to as the winding pitch.

In general, the conductor members of the hairpins of a winding have a same spacing relative to one another which corresponds to a standard winding pitch. They are called standard hairpins. For example, if a winding has a hole count of three, then two or three parallel coil strands are guided in three immediately adjacent slots and are provided for connecting to a same phase. Accordingly, in a winding for three phases, the standard coil pitch is nine.

On the head side, owing to the uniform winding pitch, the standard hairpins form a homogeneous pattern over the circumference with winding heads extending in parallel, except for in the region of the connection pins.

In order for the connection pins of a coil strand to be arranged close together so as to be easily connectable to a busbar, the coil strand must undergo at least one change in winding direction in the winding. For example, if the connection pins are provided in the radially inner layer, the coil strand starts in the radially inner layer, continues over the middle layers in one winding direction until the radially outer layer where it changes winding direction, and then continues over the middle layers in the opposite winding direction until it arrives in the inner radial winding layer again. A layer change takes place after every passage through a slot except for in the region of the change of direction. The layer change happens on the twist side in that the contact regions of two hairpins which are electrically connected one behind the other are shaped toward one another and welded together radially one behind the other. A corresponding offset is formed in the winding head on the head side so that the two parallel conductor members of a hairpin can be arranged tension-free in two adjacent layers at a slight offset relative to one another.

The region in which the change of direction is carried out is referred to as the return region. The hairpins used there are referred to as return hairpins and, like the standard hairpins, are located radially next to one another and are designed for a standard winding pitch, their parallel conductor members being arranged in one layer in this case. The return region refers to that region in which the two or three coil strands of a coil undergo the change in winding direction and is delimited by the respective outer slots occupied by the conductor members in question.

A winding with hairpins for an electric component of an electric machine with at least one phase, a hole count of at least three, and two parallel-connected coil strands per phase is known from DE 10 2018 203 471 A1. With some exceptions, the two parallel conductor members of a hairpin generally have a distance from one another that corresponds to a standard winding pitch and is given as the product of the hole count and the quantity of phases. The connection pins are arranged in a same layer, which is why there must be a return region in which a change in the winding direction takes place. This is located on the twist side and therefore has no influence on the use of a standard hairpin or a hairpin with a winding pitch deviating from a standard winding pitch.

The object of the invention is to suggest a winding with hairpins and a return region on the head side which widens the diversity of possibilities for carrying out different winding patterns.

The above-mentioned object is met for a hairpin winding for an electric component of an electric machine with at least one phase, a hole count of at least three, and two or three parallel-connected coil strands per coil and phase, wherein the hairpin winding extends over a first outer layer, a plurality of middle layers and a second outer layer with a changing winding direction, and the coil strands have connection pins at their ends on a head side of the winding, all of which are arranged in one of the outer layers, and comprise a plurality of hairpins which are connected in series and which comprise, in each instance, two parallel conductor members with two ends on a twist side of the winding and a winding head connecting the latter on the head side, wherein the parallel conductor members have a distance from one another that corresponds to a winding pitch of the hairpin winding, and wherein the coil strands have at least one return region per coil on the head side in which the winding direction is reversed, wherein the hairpins in the return region (4) are return hairpins, and the return hairpins of at least two of the winding strands have a winding pitch deviating from a standard winding pitch equal to the product of the hole count and quantity of phases.

Advantageous embodiments are indicated in the dependent claims.

The invention will be described in the following referring to an embodiment example shown in the drawings. The drawings show:

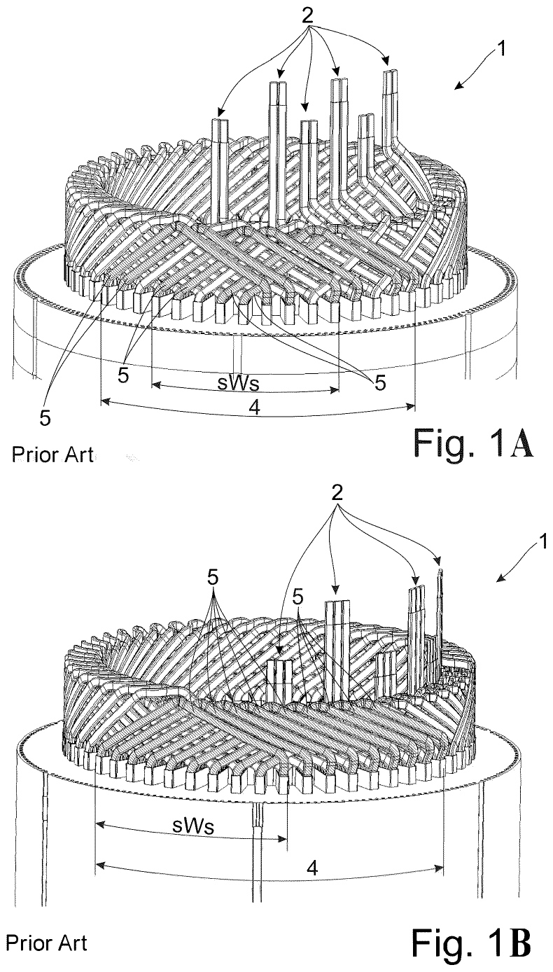

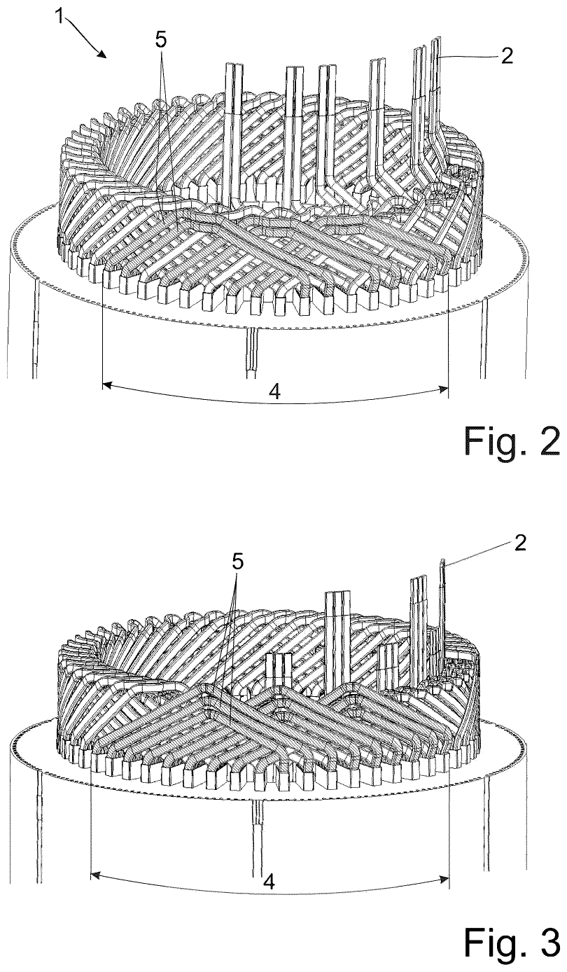

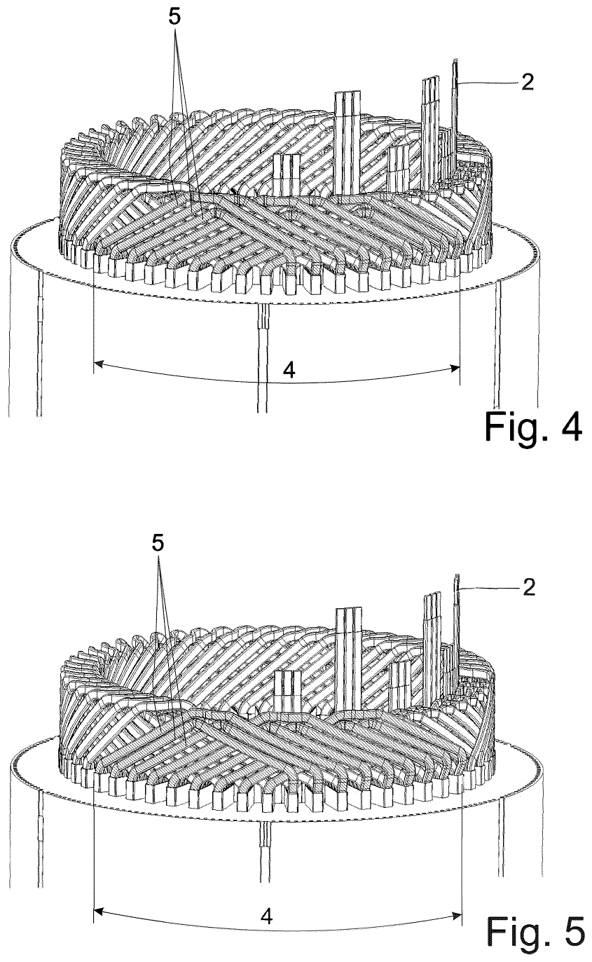

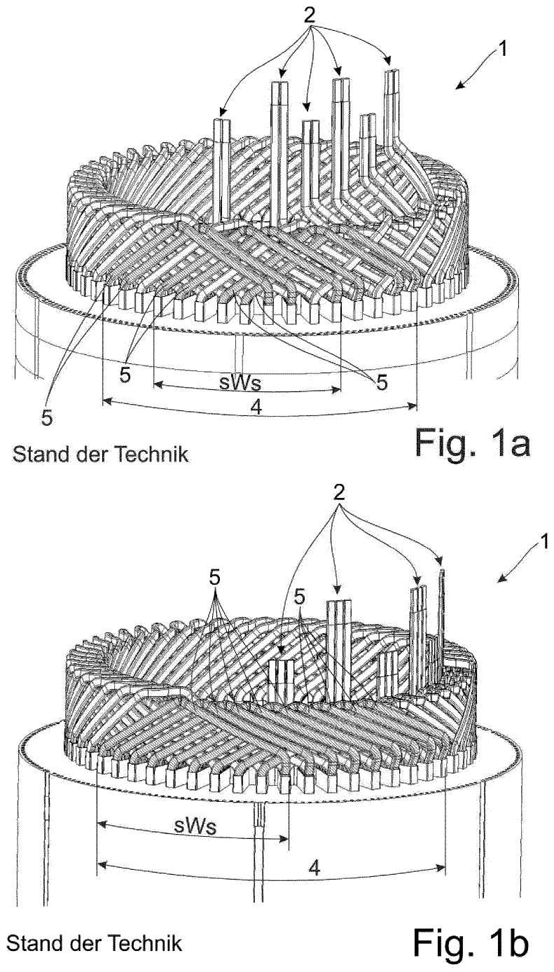

FIG. 1a a head-side portion of a hairpin winding which is inserted in a coil body and which has two parallel-connected coil strands per coil, according to the prior art;

FIG. 1b the head-side portion of a hairpin winding which is inserted in a coil body and which has three parallel-connected coil strands per coil, according to the prior art;

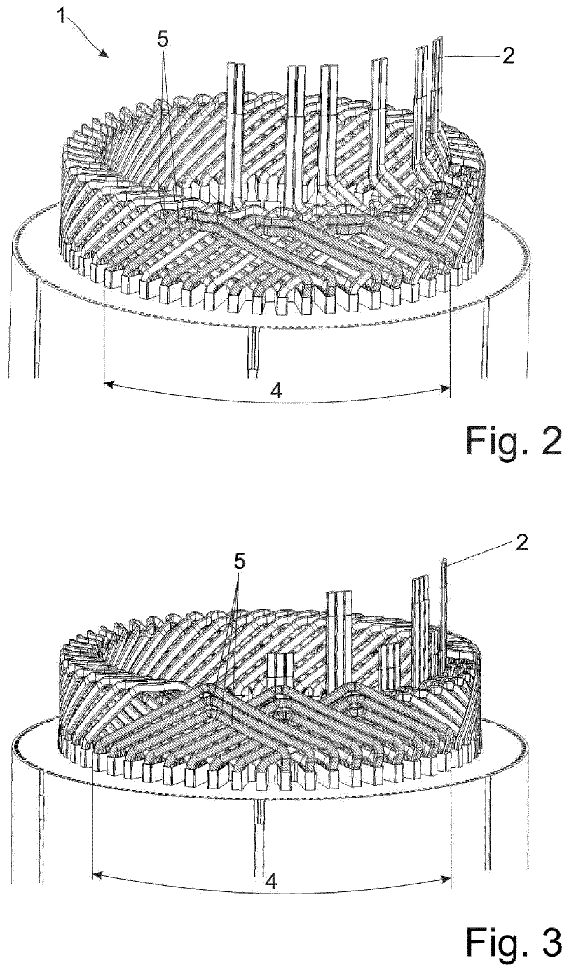

FIG. 2 the head-side portion of a hairpin winding which is inserted in a coil body and which has two parallel-connected coil strands per coil, according to an embodiment example;

FIG. 3 the head-side portion of a hairpin winding which is inserted in a coil body and which has three parallel-connected coil strands per coil, according to a first embodiment example;

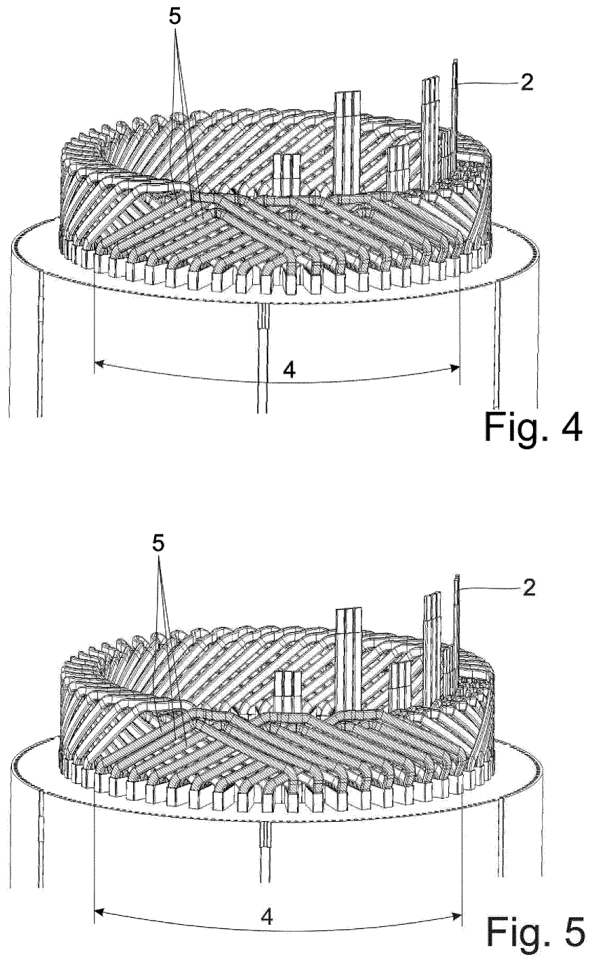

FIG. 4 the head-side portion of a hairpin winding which is inserted in a coil body and which has three parallel-connected coil strands per coil, according to a second embodiment example;

FIG. 5 the head-side portion of a hairpin winding which is inserted in a coil body and which has three parallel-connected coil strands per coil, according to a third embodiment example.

As in a prior art known from practice, shown in FIGS. 1a and 1b, a winding according to the invention has three phases, a hole count of three, and two or three parallel-connected coil strands per coil and phase. The coil strands comprise, in each instance, a plurality of hairpins connected in series, the ends of the coil strands being formed on the head side 1 of the winding in an outer layer of the winding by a connection pin 2 in each instance which is embodied as an I-pin. The hairpins comprise, in each instance, two parallel conductor members with two ends which form, in each instance, a contact region on a twist side of the winding, not shown in FIGS. 1a and 1b. Each contact region is welded with a contact region of an upstream or downstream hairpin, respectively, forming a weld joint. On the head side, the conductor members are monolithically connected to one another via a winding head. The two parallel conductor members have a distance from one another corresponding to a winding pitch.

The winding extends in a winding direction starting in a first outer layer and proceeding over a plurality of middle layers into a second outer layer where the winding direction changes and then back to the first outer layer over the middle layers. One of the two outer layers may also be referred to as an inner layer with respect to the cylindrical shape of the hairpin winding. The region in which the change in winding direction takes place in one of the outer layers is considered to be the return region. While the winding direction is maintained, the weld joints are arranged in one direction one behind the other in circumferential direction of the winding. After the change in direction, they are arranged one behind the other in the other direction in circumferential direction of the winding. A hairpin which is associated with a different winding direction relative to the hairpin immediately upstream thereof as the hairpin immediately upstream is a return hairpin within the meaning of this description.

The hairpins generally have a standard winding pitch sWS equal to the product of the hole count and the quantity of phases. According to the prior art shown in FIGS. 1a and 1b, the return hairpins also have a standard winding pitch sWS.

It is key to the invention that at least two of the return hairpins of the two or three parallel-connected coil strands per coil have a winding pitch deviating from a standard winding pitch (sWS) equal to the product of the hole count and quantity of phases.

An embodiment example for a hairpin winding with two parallel-connected coil strands per coil is shown in FIG. 2. In this instance, there are three times two equals six return hairpins within the return region. A first return hairpin of the respective two return hairpins (5) (shaded) has a winding pitch equal to the standard winding pitch (sWS) plus one and a second of the respective two return hairpins (5) (dotted) has a winding pitch equal to the standard winding pitch (sWS) minus one. Consequently, the two return hairpins (5) of a coil lie axially one above the other in each instance. As a result, in addition to the change in winding direction, the coil strands exchange their relative position in the winding direction with one another. A new winding pattern results for two parallel-connected coil strands, respectively.

A first embodiment example for a hairpin winding with three parallel-connected coil strands per coil is shown in FIG. 3. Within the return region, there are three times three equals nine return hairpins. In this instance, a first of the three return hairpins (5) (shaded) has a winding pitch equal to the standard winding pitch (sWS) plus two, a second of the three return hairpins (5) (dotted) has a winding pitch equal to the standard winding pitch (sWS), and a third of the three return hairpins (5) (indicated by crosses) has a winding pitch equal to the standard winding pitch (sWS) minus two. Consequently, the three return hairpins (5) of a coil lie axially one above the other in each instance. As a result, in addition to the change in winding direction, two of the three coil strands exchange their relative position in the winding direction relative to one another. There results a new winding pattern for three parallel-connected coil strands in each instance.

A second embodiment example for a hairpin winding with three parallel-connected coil strands per coil is shown in FIG. 4. Within the return region, there are also three times three equals nine return hairpins in this case. In this instance, a first of the three return hairpins (5) (shaded) has a winding pitch equal to the standard winding pitch (sWS) plus one, a second of the three return hairpins (5) (dotted) has a winding pitch equal to the standard winding pitch (sWS) plus one, and a third of the three return hairpins (5) (indicated by crosses) has a winding pitch equal to the standard winding pitch (sWS) minus two. Consequently, the three return hairpins (5) of a coil lie axially one above the other in each instance. As a result, in addition to the change in winding direction, the three coil strands exchange their relative position in the winding direction relative to one another. There results a further new winding pattern for three parallel-connected coil strands in each instance.

A third embodiment example for a hairpin winding with three parallel-connected coil strands per coil is shown in FIG. 5. Within the return region, there are also three times three equals nine return hairpins in this case. In this instance, a first of the three return hairpins (5) (shaded) has a winding pitch equal to the standard winding pitch (sWS) plus two, a second of the three return hairpins (5) (dotted) has a winding pitch equal to the standard winding pitch (sWS) minus one, and a third of the three return hairpins (5) (indicated by crosses) has a winding pitch equal to the standard winding pitch (sWS) minus one. Consequently, the three return hairpins (5) of a coil lie axially one above the other in each instance. As a result, in addition to the change in winding direction, the three coil strands exchange their relative position in the winding direction relative to one another. There results a yet another new winding pattern for three parallel-connected coil strands in each instance.

### REFERENCE NUMERALS

1 head side
2 connection pin
4 return region
5 return hairpin
sWS standard winding pitch

1.-10. (canceled)

11. A Hairpin winding for an electric component of an electric machine with at least one phase, a hole count of at least three, and two or three parallel-connected coil strands per coil and phase,
wherein the hairpin winding extends over a first outer layer, a plurality of middle layers and a second outer layer with a changing winding direction, and the coil strands have connection pins at their ends on a head side of the winding, all of which are arranged in one of the outer layers, and comprise:
a plurality of hairpins which are connected in series and which comprise, in each instance, two parallel conductor members with two ends on a twist side of the winding and a winding head connecting the latter on the head side,
wherein the parallel conductor members have a distance from one another that corresponds to a winding pitch of the hairpin winding, and
wherein the coil strands have at least one return region per coil on the head side in which the winding direction is reversed,
wherein the hairpins in the return region are return hairpins, and the return hairpins of at least two of the winding strands have a winding pitch deviating from a standard winding pitch (sWS) equal to a product of the hole count and quantity of phases.

12. The hairpin winding according to claim 11, wherein the winding has exactly two parallel-connected coil strands per coil,
wherein a first return hairpin of the two return hairpins has a winding pitch equal to the standard winding pitch (sWS) plus one, and
wherein a second return hairpin of the two return hairpins has a winding pitch equal to the standard winding pitch (sWS) minus one,
as a result of which the two return hairpins of a coil lie axially one above an other in each instance and, in addition to the change in winding direction, the coil strands exchange their relative position in the winding direction with one another.

13. The hairpin winding according to claim 11, wherein the winding has exactly three parallel-connected coil strands per coil, and
a first return hairpin of the three return hairpins has a winding pitch equal to the standard winding pitch (sWS) plus two,
a second return hairpin of the three return hairpins has a winding pitch equal to the standard winding pitch (sWS), and
a third return hairpin of the three return hairpins has a winding pitch equal to the standard winding pitch (sWS) minus two,
as a result of which the three return hairpins of a coil lie axially one above an other in each instance and, in addition to the change in winding direction, two of the three coil strands exchange their relative position in the winding direction with one another.

14. The hairpin winding according to claim 11, wherein the winding has exactly three parallel-connected coil strands per coil, and
a first return hairpin of the three return hairpins has a winding pitch equal to the standard winding pitch (sWS) plus one,
a second return hairpin of the three return hairpins has a winding pitch equal to the standard winding pitch (sWS) plus one, and
a third return hairpin of the three return hairpins has a winding pitch equal to the standard winding pitch (sWS) minus two,
as a result of which the three return hairpins of a coil lie axially one above an other in each instance and, in addition to the change in winding direction, the three coil strands exchange their relative position in the winding direction with one another.

15. The hairpin winding according to claim 11, wherein the winding has exactly three parallel-connected coil strands per coil, and
a first return hairpin of the three return hairpins has a winding pitch equal to the standard winding pitch (sWS) plus two,
a second return hairpin of the three return hairpins has a winding pitch equal to the standard winding pitch (sWS) minus one, and
a third return hairpin of the three return hairpins has a winding pitch equal to the standard winding pitch (sWS) minus one,
as a result of which the three return hairpins of a coil lie axially one above an other in each instance and, in addition to the change in winding direction, the three coil strands exchange their relative position in the winding direction with one another.

16. A hairpin winding according to claim 11, wherein the at least one return region is located in one of the outer layers, and the connection pins are located in an other one of the outer layers.

17. A stator for an electric machine with at least one phase, a hole count of at least three, and two or three parallel-connected coil strands per coil and phase, comprises:
a hairpin winding,
wherein the hairpin winding extends over a first outer layer, a plurality of middle layers and a second outer layer with a changing winding direction, and the coil strands have connection pins at their ends on a head side of the winding, all of which are arranged in one of the outer layers, and comprise:
a plurality of hairpins which are connected in series and which comprise, in each instance, two parallel conductor members with two ends on a twist side of the winding and a winding head connecting the latter on the head side,
wherein the parallel conductor members have a distance from one another that corresponds to a winding pitch of the hairpin winding, and
wherein the coil strands have at least one return region per coil on the head side in which the winding direction is reversed,
wherein the hairpins in the return region are return hairpins, and the return hairpins of at least two of the winding strands have a winding pitch deviating from a standard winding pitch (sWS) equal to a product of the hole count and quantity of phases.

18. An electric machine for an electric axle drive, wherein it comprises a stator according to claim 17.

19. An electric axle drive for a motor vehicle, wherein it comprises an electric machine according to claim 18.

20. A motor vehicle, wherein it comprises an electric axle drive according to claim 19.
